(19) United States
(12) Patent Application Publication
(10) Pub. No.: US 2013/0324167 A1
(43) Pub. Date: Dec. 5, 2013

(54) Wireless, multi-room ring and text notification system for cellular devices

(71) Applicant: John A. Bevil, Amarillo, TX (US)

(72) Inventor: John A. Bevil, Amarillo, TX (US)

(21) Appl. No.: 13/507,047

(22) Filed: May 31, 2012

(51) Int. Cl. H04W 68/00

(52) U.S. Cl. 455/458

(57) ABSTRACT

Apparatus includes a base station with wireless protocol such as Bluetooth, or microphones or acoustical means for detecting and receiving the ringing or alerting signal from a cellular device(s), and transmits this signal wirelessly to one or more remote receiver unit(s), where the signal is amplified and reproduced by a speaker. When the mobile device(s) are within the base station's wireless connectivity zone, the base station synchronizes with the mobile device(s) so that when an incoming call, or text, or data is detected, the base station receives the incoming call and wirelessly transmits the incoming signal to the remote receiver where it is audible to those within earshot of the remote receiver(s). Both base and/or remote speaker units may also serve as charging stations for the mobile devices.

The present invention relates to a wireless cellular ring and text notification, amplification, and communication system and a method of providing an alert or other notification of incoming data received by a mobile device when the mobile device is in a remote location, for instance, when the user is in one room and the mobile device is located in another room and/or beyond hearing range.

It is becoming more common for many households to possess only a cell phone or similar communication device and to no longer have fixed line telephone service. There is a need to ensure that calls to the cell phone or other device are not missed because the device was left somewhere else in the home, for example, when the cell phone is in one room and the occupants are in another room, or perhaps when the occupants are asleep in one room and the cell phone(s) are charging overnight on a charger located in another room. Similarly, the mobile device may have inadvertently been left in silent or vibrate mode such that incoming calls are likely to go unnoticed. It is particularly important that urgent, safety related, or even emergency phone calls are not missed because the mobile device is located in one room and the intended recipient of the incoming call is located in another room or beyond range of the mobile device's ring notification capabilities.

U.S. Pat. No. 4,962,528 (Oct. 9, 1990), Herrera, describes apparatus that amplifies an audible signal from a pager and drives the bell of a local land line telephone. However, in the absence of a land line telephone (because cell phones are rapidly becoming the only method of communication within the household), the apparatus disclosed in that prior patent is of limited use and the methods and devices disclosed in other prior art patents are also characterized by enough disadvantages and limitations that a need exists for an apparatus that synchronizes with cell phone devices and allows the devices to be heard ringing from other rooms in the house, day or night, 24/7, even when the phone may be set to silent or vibrate. A need also exists for a device that provides the ability to answer a cell phone remotely, for instance, from another room in the house.

It is therefore an object of the present invention to provide a base station apparatus with charging capabilities with options for a microphone, hard-wired and or wireless connecting auto-synchronization to pick up the incoming ring or text (ringing or alerting sound) of the mobile device(s), and with radio communication that transmits an audio link of the inbound signal to one or more remote receiver units that are provided with speakers to alert the user of an incoming call or text to the mobile device, even when the user is out of hearing range of their cellular device's ring notification capabilities.

It is also an object of the present invention to provide an apparatus including a base station unit that makes provision for multiple mobile devices and, when the cellular devices are located within the base station's wireless connectivity zone or within range of the base station's microphones or connected to the base station via hard-wire or via wireless communication protocol (such as Bluetooth), the base station relays the ringing sound(s) or the inbound text signals of the devices wirelessly to one or more remote receiving units so that the users never need be out of earshot of their devices. Users are thus able to hear their devices when they are located within the base station's wireless connectivity zone so long as the user is in hearing range of a remote receiver unit.

Another object of the present invention is to provide a ringing repeater system using wireless technology and a method of providing a ring or other alert upon receipt of a telephone call, text or page or in response to some other of the many functions of commonly available mobile devices.

Another object of the present invention is to provide an apparatus and method that repeats, or transmits, a signal wirelessly received by the base station unit, from the mobile device, to a remote receiving unit even if the ringer alert of the mobile device is turned off and/or has been changed to vibrate only or silent mode.

Another object of the present invention is to provide a remote ringing repeater system that is capable of being expanded by adding more base station units and/or remote receiver units and as such, is designed so that multiple systems may be used in the same building or other location without interference or cross-over with each other.

Other objects, and many of the advantages of the present invention, will be made clear to those skilled in the art in the following detailed description of the preferred embodiment(s) of the invention and the drawings appended hereto. Those skilled in the art will recognize, however, that the embodiment(s) of the present invention that are described herein are only examples of specific embodiment(s), set out for the purpose of describing the making and using of the present invention, and that the embodiment(s) shown and/or described herein are not the only embodiment(s) of a method and apparatus constructed and/or performed in accordance with the teachings of the present invention.

The present invention is an apparatus for transmitting a signal from a mobile device in a first location (the base station unit) to a device in a remote location (the remote receiving unit) for interacting, including two-way communications, with a mobile device, including circuitry in the base station unit for detecting an incoming signal to the mobile device, and a transmitter operably connected to the signal detection circuitry. A remote receiving unit includes a receiver for detecting a signal from the transmitter and a loudspeaker for producing sound upon receipt of a signal transmitted by the base station unit. In an alternative embodiment, the remote receiving unit is a transceiver, allowing for two-way direct open-line connectivity and communication with the cellular device located at the base station unit.

In another aspect, a method of relaying a signal incoming to a mobile device is provided, the method comprising the steps of detecting the incoming signal to a mobile device and transmitting a signal upon detection of the incoming signal to the mobile device. The transmitted signal is received at a location remote from the mobile device and an alert is produced upon receipt of the transmitted signal.

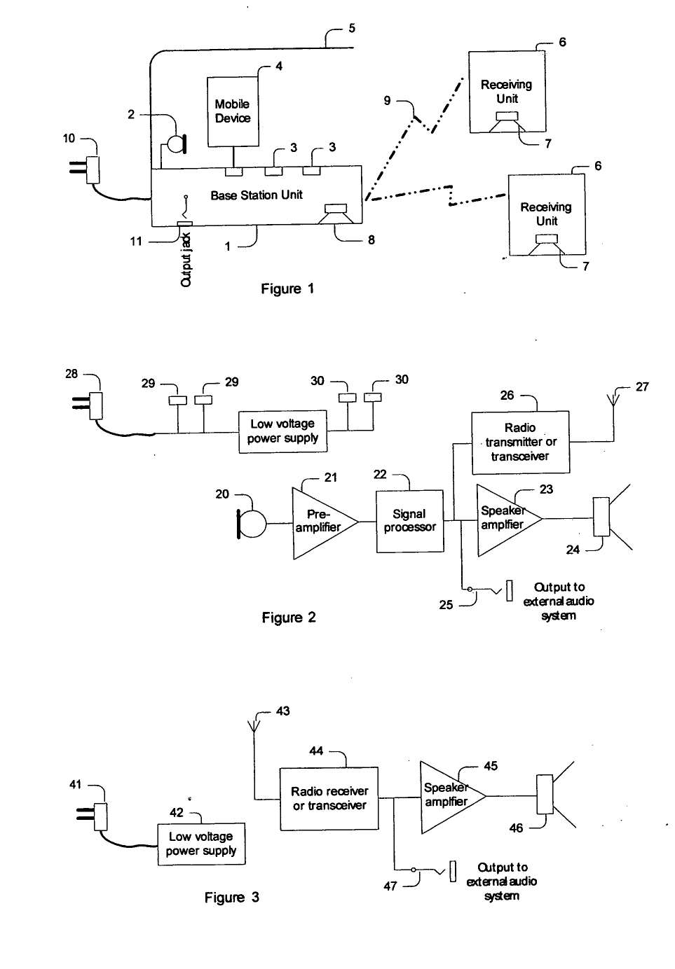

Referring to the figures, FIG. 1 is a schematic diagram of the component parts of a first embodiment of an apparatus constructed in accordance with the present invention.

FIG. 2 shows an electronic block diagram of the base station unit shown schematically in FIG. 1, showing the signal flow from a microphone via a pre-amplifier to a signal processing block, and thence to a radio and/or to an output jack socket or amplifier for driving an internal speaker.

FIG. 3 shows an electronic block diagram of the remote receiving unit shown schematically in FIG. 1, showing the signal flow from an antenna to a radio, thence to an output jack socket and to an amplifier driving a speaker internal to the remote receiving unit, the remote receiving unit also being capable of two-way communications via the base station unit for direct open line connectivity with cellular device that has been synchronized with the base station of FIG. 2.

A base station unit 1 in FIG. 1 includes a pad or cradle, preferably formed on base station unit 1, in which one or more mobile devices 4, which can include telephones, pagers, portable computing devices or any other portable electronic devices, is docked or placed adjacent to base station 1 for connectivity with the base station, and also if so desired, for recharging these devices. Base station unit 1 includes a plurality of power output sockets 3 that are of a suitable type to deliver 110V or 230V mains power or low voltage power using, for example, a USB socket or suitable power adapters or power leads to the mobile devices. In another embodiment, the mobile devices are recharged wirelessly using an inductive scheme as known in the art.

The preferred method for synchronizing a cell phone to base station unit 1 is by secure wireless personal area network (PAN), preferably in the ISM band from 2400-2480 MHz (Bluetooth) or similar methods, as known in the art (see below). However, to provide connectivity for cellular devices that do not possess PAN connective technology, a microphone 2 is positioned to receive the acoustic ring or other alert signal from the mobile devices. Alternatively, a cabled connection is made between base station unit 1 and each mobile device. Regardless of whether the ring or alert is detected acoustically, via cabled connection, or wirelessly via PAN, the signal is sent by radio link (schematically shown as 9) to a plurality of remote receiving units 6, each remote receiving unit 6 including a loudspeaker and volume control 7. Although not a required element of the invention, suitable signal processing circuitry and/or software routines stored in the memory of a microprocessor may be included within base station unit 1 to ensure that other sounds, including conversations in the vicinity of the base station unit, are not relayed. Appropriate filtering, also as known in the art, may be provided to reduce or eliminate the relay of noise from such sources as AC lines, microwaves, wireless Internet networks, and the like. Further, an acoustic hood or cover 5 may be included to improve the performance of the system. More than one microphone, or other suitable transducer, may also be included to improve performance. In a second embodiment, or as an adjunct to acoustic detection of the ring tone, base station unit 1 is provided with sensors and circuitry for detecting radio frequency emissions from the mobile device, as these emissions become more frequent when an incoming call is being signaled, and to use the detected signal as an input to the signal processing element.

Base station unit 1 may optionally include a loudspeaker 8 and volume control for local amplification of the ring or alert signal and also an output jack socket 11 that feeds those signals to an existing audio system or public address system. A mains cable and mains connector 10 provides power to base station unit 1 and to the sockets 3.

When a mobile device is placed near, on top of, or plugged into the base station unit 1 to charge, the ring or other alert signal from the device is transmitted to a remote receiving unit 6. One or more remote receiving units 6 is/are placed in other rooms of a building and/or throughout the rooms of a house or other building.

Depending upon whether the base station unit 1 utilizes Bluetooth technology or other PAN connectivity for auto-synchronization of mobile devices when the devices are in close proximity, the general range for when such devices are able to sync with base station unit 1 is approximately zero and eight feet (0′ to 8′) or greater. Once a mobile device enters the “sync” zone, and as long as the device remains within the “sync” zone, base station unit 1 serves as the receiver and transmitter for incoming calls, text, or data. As set out below, base station unit 1 then wirelessly transmits the incoming signal to all remotely located remote receiver units 6 associated with base station unit 1. Additional base station units (not shown) may be utilized in the same location (residence, office, etc.) and are designed such that they will not interfere with each other.

FIG. 2 shows a block diagram of the signal flow and power supplies in base station unit 1. Via an incoming Bluetooth signal or one or more microphones 20, or by way of a hard-wire connection, signals from the mobile devices are input to a pre-amplifier 21 the output of which feeds a signal processor block 22. The signal processor 22 may be a simple noise gate so that ambient sounds or nearby conversations are not amplified, or it may be a more complex subsystem capable of recognizing particular ringing or alerting signals and optionally translating them into another form, which may include a synthesized vocal alert of the person whose mobile device is ringing or alerting, or a non-audio indication to the remote receiver units, which then synthesizes an audio alert locally within the remote receiver unit 6. A speaker amplifier 23 drives a local speaker 24 that is optionally provided with a volume control. A jack socket or similar audio socket 25 provides an output that may be connected to an audio system or public address system (not shown).

A low-powered radio transmitter or transceiver 26 and antenna 27 feed the output wirelessly to the remote receiving units 6 as described above. Alternatively, radio signals are sent over the power wiring within the building using apparatus and methods known in the art. The radio topology may be broadcast, so that a single transmitter 26 sends the ringing or alerting signal to all remote receiving units 6 via one carrier, or it may establish a separate connection between the base station unit 1 and each remote receiving unit 6 using communication protocols known in the art. The latter arrangement has the advantage that all communication can be confirmed regularly, an indication or warning being given to the user if a particular remote receiving unit 6 is not operating or is out of range. One or more indicator lights may be provided on either the base station unit 1 or the remote receiving units 6, or both base station and remote receiving units, to confirm that communication has been confirmed and/or to warn of its absence, or both. The base station unit 1 and each remote receiving unit 6 may be “paired” together either by a user procedure or as part of the manufacturing process in, for instance, the same way a cordless earpiece or telephone is associated with its handset or base respectively and as known in the art. Alternatively, base station unit 1 is provided with means to code its transmission by, for example, a number of switches to set a binary code or a number of rotary switches to set a decimal or hexadecimal code, and the remote receiver units 6 are provided with similar means to set the code they detect all as also known in the art.

The power connector and lead 28 provide power at 110V or 230V, optionally via a main power switch, or may provide low voltage power (so that then entire unit operates under the requirements of a low-voltage utility), via suitable fuse or other protective device, to mains power outlets 29, and also to a low voltage power supply 30 that feeds power to the low voltage sockets 31, which may be USB socket or any other suitable type of socket. Power supply 31 also provides power to the electronic circuitry within base station unit 1. The radio link preferably uses a frequency band that does not require a user license; for example, the 902 MHz or 2.4 GHz ISM bands, or the DECT 6.0 band at 1920 MHz (or the equivalent bands in other countries or regions), and may also be similar in nature to Bluetooth wireless technology as is familiar to those in the art.

FIG. 3 shows a block diagram of the signal flow and power supplies in remote receiving unit 6. Remotely located remote receiving units 6 are placed in multiple locations throughout the building/household and whenever there is an incoming call, text, or other signal, base station unit 1 sends the signal (wirelessly) to all remote receiving units 6 where the signal is replicated, amplified, and announced over the speaker within remote receiver unit 6. Each remote receiver unit 6 may be provided with a volume control, on/off power switch, a light indicating that the remote receiver unit is synchronized with the base station unit, a USB charging port, and an external speaker port. Remote receiver unit 6 preferably operates off of low voltage current and may also be equipped with a microphone and transmitter for communicating with cellular units located at the base station unit, by opening up a channel, similarly to how a wireless Bluetooth headset is able to communicate with a synchronized cell phone.

In more detail and referring to FIG. 3, an antenna 43 connects to a radio receiver or transceiver 44. Alternatively, radio signals are received from the power wiring within the building. A speaker amplifier 45 feeds a speaker 46 internal to the remote receiving unit. Amplifier 45 optionally includes a volume control. Optionally a jack socket or similar audio socket 47 provides an output that may be connected to an external audio system. A mains plug 41 and low voltage power supply 42, which may alternatively be an external self-contained power adapter, provide electrical power to remote receiving unit 6.

Those skilled in the art who have the benefit of this disclosure will also recognize that certain changes can be made to the component parts of the apparatus of the present invention without changing the manner in which those parts function and/or interact to achieve their intended result. For example, especially for use by hearing impaired individuals, receiving unit 6 may be provided with a display and circuitry for producing a textual, numerical, or other display upon receipt of a signal from the base station unit 1. Similarly, either of base or receiving units 1, 6 may be provided with an output for connecting to a computer for use of the messaging, data transmission, and other functions available through interaction with the computer. Receiving unit 6 may also be integrated with devices for remote operation of such systems as alarm, audio-visual, or security cameras and recorders so that such systems can be activated upon receipt of a particular signal by the mobile device residing on base unit 1. As will also be apparent to those skilled in the art, either or both of the receivers in base and receiving units 1, 6 may be transceivers and base unit I may be provided with circuitry for interacting with the mobile device such that the present invention functions as a repeater system enabling the use of a mobile device residing on base unit 1 from the remote receiving unit 6. All such changes, and many others that will be clear to those skilled in the art from this description of these several embodiment(s) of the invention, are intended to fall within the scope of the following, non-limiting claims.

What is claimed is:

1. Apparatus for receiving a signal from a mobile device in a first location and transmitting a signal to a remote location upon receipt of the signal from the mobile device comprising:
a base station unit for interacting with a mobile device;
circuitry in said base station unit for detecting an incoming signal to the mobile device;
a transmitter operably connected to said signal detection circuitry;
a remote receiving unit including a receiver for detecting a signal from said transmitter; and
a loudspeaker for producing sound upon receipt of a signal by said receiving unit.

2. The apparatus of claim 1 wherein the signal detecting circuitry in said base station unit produces a signal that is received by the receiver in said remote receiving unit and that causes a sound to be produced by the loudspeaker that is representative of a particular signal incoming to the mobile device.

3. The apparatus of claim 1 wherein the signal detecting circuitry, transmitter, receiver, and loudspeaker reproduce a sound produced by a mobile device.

4. The apparatus of claim 1 wherein said base station unit additionally comprises at least one charger for a mobile device.

5. The apparatus of claim 1 wherein the signal detecting circuitry of said base station unit detects an incoming signal to the mobile device via personal area network.

6. The apparatus of claim 1 wherein the transmitter of said base station unit transmits either wirelessly or over available AC lines.

7. The apparatus of claim 1 wherein an incoming signal to the mobile device is detected by said base station unit either acoustically by a microphone, wirelessly by detecting an increase in radio frequency emissions by the mobile device, wirelessly by personal area network, or by making a hard-wired connection between said mobile device and said base station unit.

8. The apparatus of claim 1 wherein said remote receiving unit additionally comprises a transmitter for communicating with said base station unit.

9. A method of relaying a signal incoming to a mobile device comprising the steps of:
detecting the incoming signal to a mobile device;
transmitting a signal upon detection of the incoming signal to the mobile device;
receiving the transmitted signal at a location remote from the mobile device; and
producing an alert upon receipt of the transmitted signal.

10. The method of claim 9 additionally comprising the step of producing an alert that reproduces the sound made by the mobile device upon receipt of an incoming signal by the mobile device.

11. The method of claim 9 wherein the signal received at the remote location is transmitted either wirelessly or over available AC lines.

12. The method of claim 9 additionally comprising filtering the signal from the mobile device before transmitting to the remote location.

13. The method of claim 9 additionally comprising the step of synchronizing the base station unit and the mobile device.

14. The method of claim 13 wherein the base station unit and the mobile device are synchronized using a personal area network.
